(19) United States
(12) Patent Application Publication
(10) Pub. No.: US 2009/0096915 A1
(43) Pub. Date: Apr. 16, 2009

(54) ANTI-ALIASING SPATIAL FILTER SYSTEM

(76) Inventors: Sean C. Kelly, Rochester, NY (US); John D. Griffith, Rochester, NY (US); Russell J. Palum, Rochester, NY (US)

Correspondence Address: EASTMAN KODAK COMPANY;PATENT LEGAL STAFF, 343 STATE STREET, ROCHESTER, NY, 14650-2201, US

(21) Appl. No.: 11/872,897

(22) Filed: Oct. 16, 2007

(51) Int. Cl. H04N 5/238

(52) U.S. Cl. 348/360

(57) ABSTRACT

A filter system for an imaging apparatus including a high resolution mode of operation and a low resolution mode of operation is provided. The filter system includes a low pass filter associated with an optical path of the imaging apparatus. The low pass filter is moveable into the optical path of the imaging apparatus when the imaging apparatus is in the low resolution mode of operation and is moveable out of the optical path of the imaging apparatus when the imaging apparatus is in the high resolution mode of operation.

### FIELD OF THE INVENTION

This invention relates generally to the field of digital motion and still photography and, more particularly, to anti-aliasing for imaging systems that have a plurality of resolution modes.

### BACKGROUND OF THE INVENTION

An electronic imaging system typically produces a signal output corresponding to a viewed object by spatially sampling an image of the object in a regular pattern with an array of photosensitive elements, such as, for example, a charge-coupled device (CCD) or Complementary Metal-Oxide Semiconductor (CMOS) solid-state image sensor. In such an imaging system, it is well known that components in the object field that contain fine details can create frequencies too high to be captured without sampling error within the sampling interval of the sensor. These details can produce lower frequency components, resulting in imaging errors commonly referred to as aliasing or undersampling artifacts. Aliasing is related to the system modulation transfer function (MTF) and, in a more pronounced manner, to the spatial periodicity of the picture elements or “pixels” of the solid-state imaging array. In particular, if the spatial detail that is being imaged contains a high frequency component of a periodicity greater than twice the pitch of the photosensitive picture elements of the image sensor, the undesirable effect of this high frequency component can be a spurious signal due to aliasing. As is familiar to those skilled in the digital imaging arts, the particular frequency above which aliasing is likely is termed the Nyquist frequency.

In general, the electronic imaging system can minimize aliasing if its optical section has a frequency response that cuts off, or filters out, the higher frequency content of the object being imaged, that is, frequencies above the Nyquist frequency. As a result, the optical section generally employs an optical low pass filter to substantially reduce the high frequency component contained in the spatial detail of the image received by the image sensor. Thus, conventional design of electronic imaging systems involves a trade-off between image sharpness, which increases with higher frequency image content, and compensation for aliasing distortions or undersampling artifacts, which reduces higher frequency image content.

To limit aliasing artifacts, an optical filter, for example, a birefringent anti-aliasing filter, has become a common component in consumer color video cameras. For example, U.S. Pat. No. 4,989,959 to Plummer and U.S. Pat. No. 4,896,217 to Miyazawa et al. show typical examples of anti-aliasing filters. Such a filter is usually placed between a lens and the image sensor in order to provide a low-pass filter function, reducing the spatial frequency content of the object at frequencies above the Nyquist frequency of the photosensitive element array. This use of an anti-aliasing filter makes the imaging system less susceptible to aliasing distortion. Another option can be using the lens to blur the image. However, this approach leads to f/# dependent blur and is, typically, not a favorable solution for image anti-aliasing.

Recently, image sensor arrays having the ability to image in multiple resolution modes have been commercialized. This innovation in imaging technology allows a single image sensor array to have both a high-resolution mode, obtaining a digital image data value from each individual pixel, and one or more lower-resolution modes, in which charge from multiple pixels can be summed, reducing the amount of data obtained and effectively obtaining information from fewer, “larger” pixels. Other methods to produce effectively larger pixels include summing pixel values digitally or summing the voltage associated with each pixel and possibly other techniques. Each resolution mode, then, has different sampling characteristics but works with an optical system exhibiting the same MTF.

Because high- and low-resolution modes respectively require different amounts of optical blur to prevent aliasing and to preserve sharpness, compensating for aliasing with such a dual-mode system can involve a considerable amount of compromise. A stationary anti-aliasing filter that is designed to anti-alias the image in the lowest resolution mode will excessively blur the image in a higher resolution mode. A stationary anti-aliasing filter that is designed for the highest resolution mode will anti-alias properly for high-resolution operation, but will not effectively compensate aliasing for all appropriate frequencies in a reduced resolution mode.

Thus, it can be seen that there is a need for solutions that provide anti-aliasing compensation for imaging systems that have multiple resolution modes.

### SUMMARY OF THE INVENTION

According to one aspect of the present invention, a filter system for an imaging apparatus including a high resolution mode of operation and a low resolution mode of operation is provided. The filter system includes a low pass filter associated with an optical path of the imaging apparatus. The low pass filter is moveable into the optical path of the imaging apparatus when the imaging apparatus is in the low resolution mode of operation and is moveable out of the optical path of the imaging apparatus when the imaging apparatus is in the high resolution mode of operation.

According to another aspect of the present invention, a multi-resolution filter system includes a plurality of low pass filters. At least some of the plurality of low pass filters are positionable on and off of an optical axis. A mechanism is operatively associated with the at least some of the plurality of low pass filters positionable on and off the optical axis. The mechanism operates to produce combinations of low pass filters positioned on the optical axis by moving one or more of the associated plurality of low pass filters laterally relative to the optical axis. Each combination of low pass filters produces distinct anti-aliasing characteristics when compared to other combinations of low pass filters.

According to another aspect of the present invention, a method of filtering in an imaging apparatus including a high resolution mode of operation and a low resolution mode of operation is provided. The method includes providing a low pass filter associated with an optical path of the imaging apparatus; moving the low pass filter into the optical path of the imaging apparatus when the imaging apparatus is in the low resolution mode of operation; and moving the low pass filter out of the optical path of the imaging apparatus when the imaging apparatus is in the high resolution mode of operation.

As embodiments of the present invention address the need for anti-aliasing with digital imaging systems that have both high- and low-resolution modes, an advantageous effect of the present invention relates to the capability of adapting anti-aliasing suitable for the resolution that is used in an imaging apparatus.

### BRIEF DESCRIPTION OF THE DRAWINGS

In the detailed description of the example embodiments of the invention presented below, reference is made to the accompanying drawings, in which:

FIG. 1A is a plan view showing a portion of a color sensor imaging array;

FIG. 1B is a plan view showing a sub-sampling of the array of FIG. 1A;

FIG. 1CA is a plan view showing a portion of an alternate color sensor imaging array;

FIG. 1D is a plan view showing a sub-sampling of the array of FIG. 1C;

FIG. 2 is a perspective view showing a sensor having two anti-aliasing filters;

FIG. 3 is a schematic diagram showing spot patterns formed from an arrangement for a first anti-aliasing filter;

FIG. 4 is a schematic diagram showing spot patterns formed from an arrangement for a second anti-aliasing filter;

FIG. 5 is a schematic diagram showing a spot pattern formed from a combination of first and second anti-aliasing filters shown in FIGS. 3 and 4;

FIG. 6A shows x-axis MTF for a anti-aliasing filter in one embodiment;

FIG. 6B shows y-axis MTF for a anti-aliasing filter in one embodiment;

FIG. 6C shows combined MTF, along the x-axis, for a pair of anti-aliasing filters used in one embodiment;

FIG. 6D shows combined MTF, along the y-axis, for a pair of anti-aliasing filters used in one embodiment;

FIGS. 7A and 7B are schematic diagrams of an imaging apparatus using a anti-aliasing filter that can be positioned in or removed from the optical path;

FIGS. 8A and 8B are schematic diagrams of an imaging apparatus that uses one of two interchangeable anti-aliasing filters; and

FIGS. 9A and 9B are schematic diagrams of an imaging apparatus that uses either one or two anti-aliasing filters in the optical path.

### DETAILED DESCRIPTION OF THE INVENTION

Apparatus and methods of embodiments of the present invention provide anti-aliasing for an imaging apparatus that can operate in a high-resolution mode of operation and in one or more lower-resolution modes. For example, the same image sensor array can operate in a high-resolution mode, effectively using each imaging pixel to provide a still image, then operate in a lower-resolution mode for capturing video images. Although the other optical components of the imaging system contribute in the same way to the system MTF under high- and low-resolution conditions, the pixel sensor array can have very different characteristics, requiring different anti-aliasing compensation. As was described above, using the same anti-aliasing filters would excessively compromise performance for one or both high- and low-resolution modes.

Reducing the effective resolution of an imaging sensor, such as using pixel summing, for example, reduces its Nyquist frequency, above which aliasing can occur. When an imaging sensor can be used in either a high- or a low-resolution mode, it effectively has two different Nyquist frequencies. The function of anti-aliasing is to filter out, as effectively as possible, frequency content above the Nyquist frequency.

To achieve this end, embodiments of the present invention position one or more anti-aliasing filters in the optical path to apply just the right amount of MTF reduction for anti-aliasing in each resolution mode. Optical low pass filtering can be performed with various anti-aliasing filter types, including birefringent filters such using quartz, lithium niobate and calcite, diffractive anti-aliasing filters such as phase noise anti-aliasing filters, and grating anti-aliasing filters, and refractive types such as the cross pleat design described in commonly assigned U.S. Pat. No. 6,326,998 entitled “Optical Blur Filter Having a Four-Feature Pattern” to Palum. Moreover, combinations using more than one type of anti-aliasing filter can be used to achieve the level of blur appropriate for each resolution mode. These anti-aliasing filters band-limit the spatial frequency content of the optical distribution imaged in the focal plane. Each combination of anti-aliasing filters produces a resultant optical image MTF that is suitable for each imager resolution mode.

As was noted earlier, the spatial periodicity, or pitch, between pixels is inversely related to the Nyquist frequency and, therefore, to the anti-aliasing cut-off frequency. With monochrome imaging, the pitch between pixels is simply the distance between each pixel and its nearest neighbor in the array. With color imaging and sub-sampling, however, the pitch between pixels can be related to their color content.

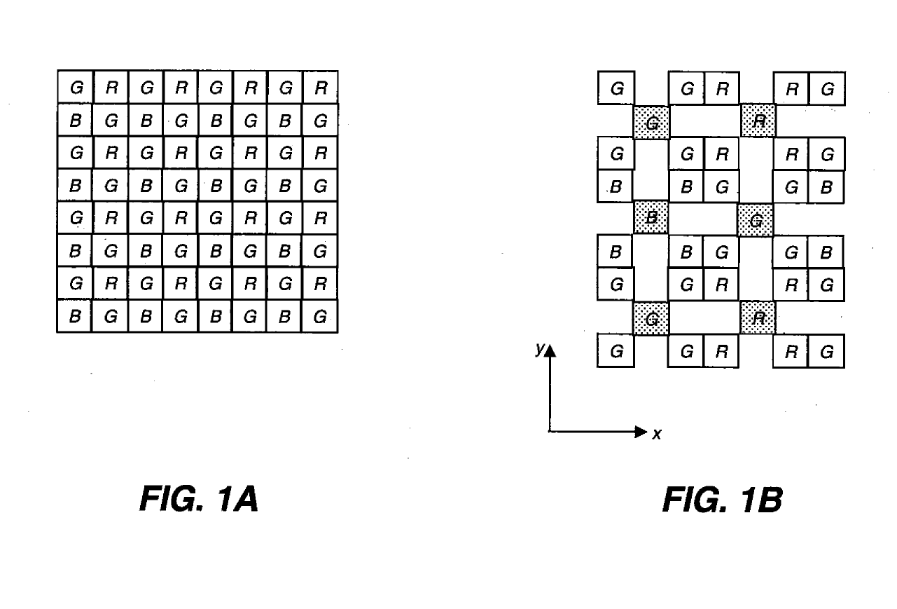

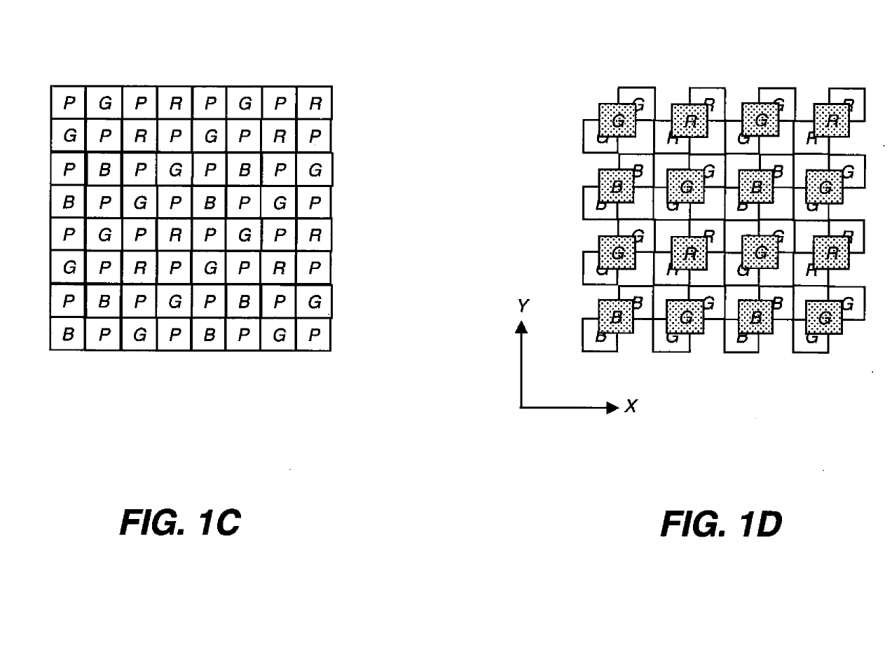

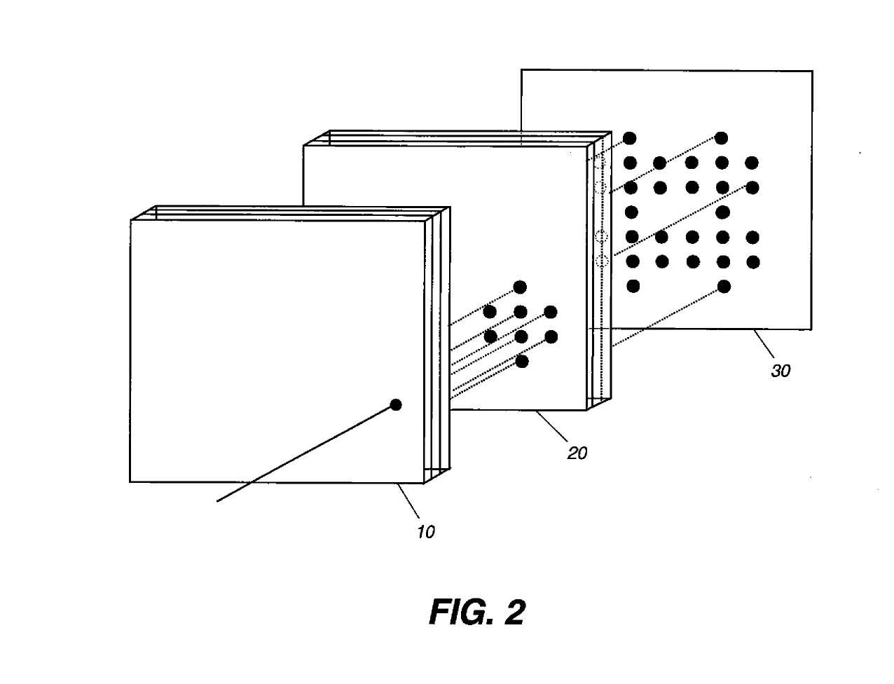

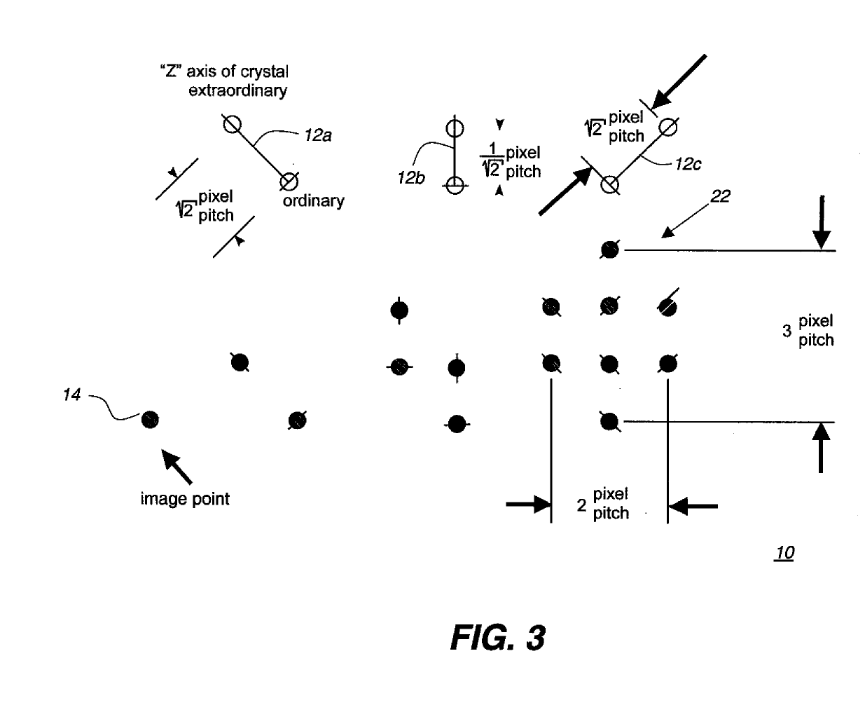

Referring to FIG. 1A, there is shown an arrangement of pixels for a color imager, using a color filter array (CFA) or other arrangement. FIG. 1A shows a small portion of a sensor imaging array that is arranged using the Bayer pattern, one type of CFA pattern that is familiar to those skilled in the color imaging arts. This pattern has twice as many Green pixels (G) as Red (R) or Blue (B) pixels. Very often the anti-aliasing filter pitch is chosen for cutoff at a ½ cycle per imager pixel pitch, even though the red and blue Nyquist frequencies are below ½ cycle per imager pixel pitch, with the green Nyquist frequency lower in some directions. Selection of this cutoff characteristic is often a compromise between sharpness and reduced artifacts due to aliasing.

Sub-sampling of the Bayer pattern can provide a larger spatial pitch, as indicated in FIG. 1B. Here, the charge signals from four Green pixels are added together or binned, so that a single pixel value can be obtained. Similarly, four Red pixels or four Blue pixels can also be binned, combined to yield the effective periodicity shown. Compared with the full imager arrangement in FIG. 1A, the sampled arrangement in FIG. 1B has every third pixel sampled (in both x and y directions). Thus, an anti-aliasing filter for the standard Bayer CFA pattern of FIG. 1A should provide a cutoff frequency at ½ cycle per sample. The filter for the sub-sampling scheme used in FIG. 1B should provide a cutoff frequency at ⅓ times the full imager frequency, that is, at ⅙ cycle per imager sample.

FIG. 1C shows an alternative CFA pattern for an image sensor having both color (RGB) pixels and panchromatic (P) pixels. Here, a sampling interpolation takes advantage of the correlation between the color pixels and the panchromatic pixels. By binning, the original pattern of FIG. 1C is sub-sampled to the equivalent Bayer CFA pattern shown in FIG. 1D. In this case, the Bayer pattern spacing has twice the pitch of the original imager, so that the Nyquist frequency for this imager is ½ the frequency of the original pattern. Thus, an anti-aliasing filter for the CFA pattern of FIG. 1C should provide a cutoff frequency at ½ cycle per sample. The filter for the sub-sampling scheme used in FIG. 1D should provide a cutoff frequency at ½ times the full imager frequency, that is, at ¼ cycle per imager sample.

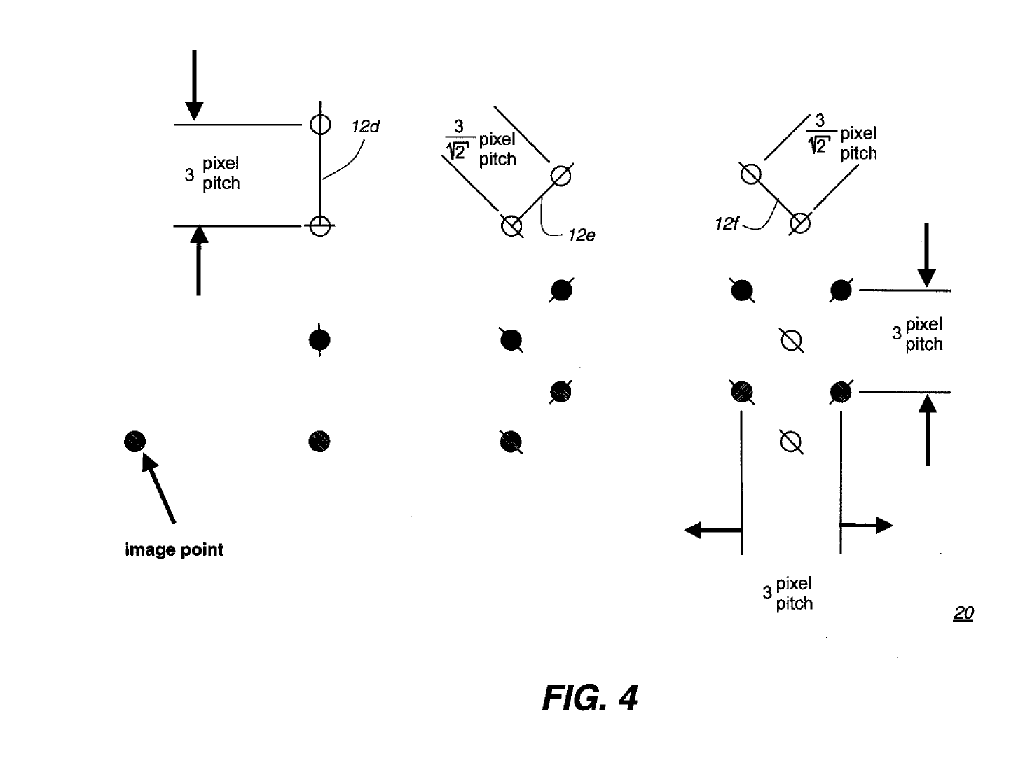

In order to suppress aliasing for the sub-sampled arrangement of FIG. 1B and thereby provide a zero at the Nyquist frequency of the sensor (here, at ⅙ cycle per sample), two anti-aliasing filters in series can be used. FIG. 2 shows this portion of an imager in a simplified schematic form. A first anti-aliasing filter 10 is designed to provide 8 spots, as shown in FIG. 2. A second anti-aliasing filter 20 is a 4-spot anti-aliasing filter, so that 32 spots are directed to an image sensing array 30 when both first and second anti-aliasing filters 10 and 20 are used. It appears from FIG. 2 that only 30 spots are formed. However, two of these spots have double the light in this arrangement, as described subsequently.

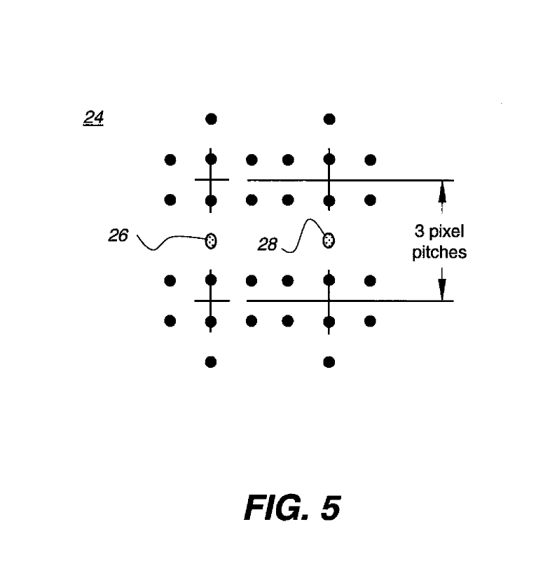

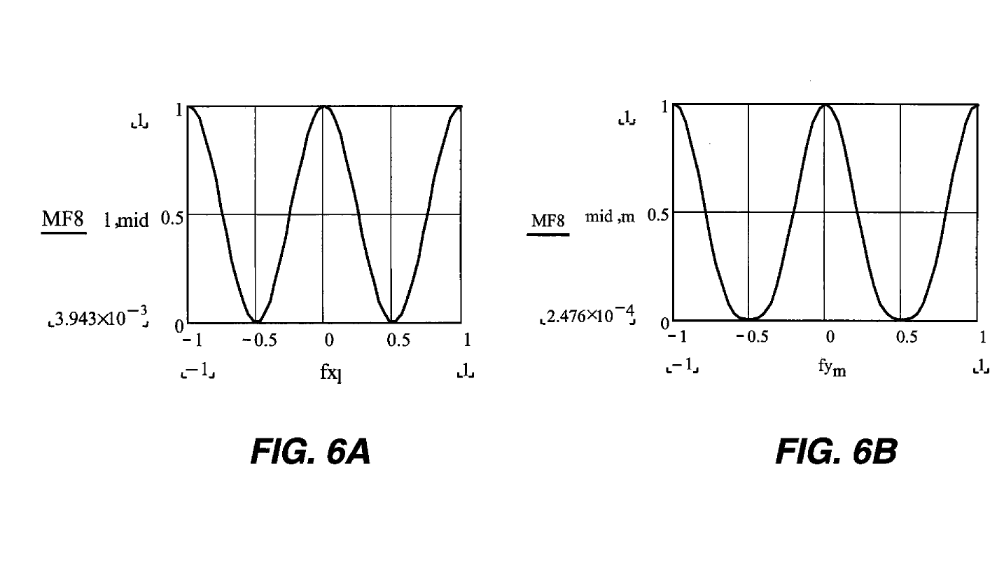

Before giving more detail about how first and second anti-aliasing filters 10 and 20 are used, it is first instructive to describe how each of these filters is formed and operates. FIG. 3 shows the sequence for the pattern of light formed by first anti-aliasing filter 10. FIG. 4 then shows how second anti-aliasing filter 20 multiplies this pattern to provide additional anti-alias filtering. It can be observed that separating beams of light using a sequence of optically coupled birefringent plates is familiar to those skilled in the optical arts. More detailed information on how this is done can be found, for example, in commonly assigned U.S. Pat. No. 6,937,283 entitled “Anti-Aliasing Low-Pass Blur Filter for Reducing Artifacts in Imaging Apparatus” to Kessler et al.

Referring now to FIG. 3, construction and operation details for first anti-aliasing filter 10 are shown. In one embodiment, three birefringent or double-refracting plates are used to form anti-aliasing filter 10. The orientations of z-axes 12a, 12b, and 12b for quartz crystal materials used in successive plates in one embodiment are shown in the upper portion of FIG. 3. The axis representation shown is a projection; first optical axis 12a is at 45 degrees to the edge of the incident surface. The E-field orientation for ordinary and extraordinary rays is indicated by the lines through the circles at each end of axes 12a, 12b, and 12c as represented in FIG. 3.

At furthest left is an image point 14 that schematically represents a light beam that would otherwise go to a single pixel for the image sensing array. Moving from left to right in FIG. 3, the sequence for splitting up this beam that is provided by the three component birefringent plates of first anti-aliasing filter 10 is shown, along with the respective pixel pitch values. The first plate separates the incident beam of light to provide two beams separated in a diagonal direction. The second double-refracting plate separates this set of beams in the vertical direction to provide four beams. The last double-refracting plate separates the set of four beams over a diagonal distance, thereby providing eight beams to form an 8-spot pattern 22 as shown. Where applicable in FIGS. 3 and 4, polarization of spots at each stage is shown schematically by the slanted line through the spot.

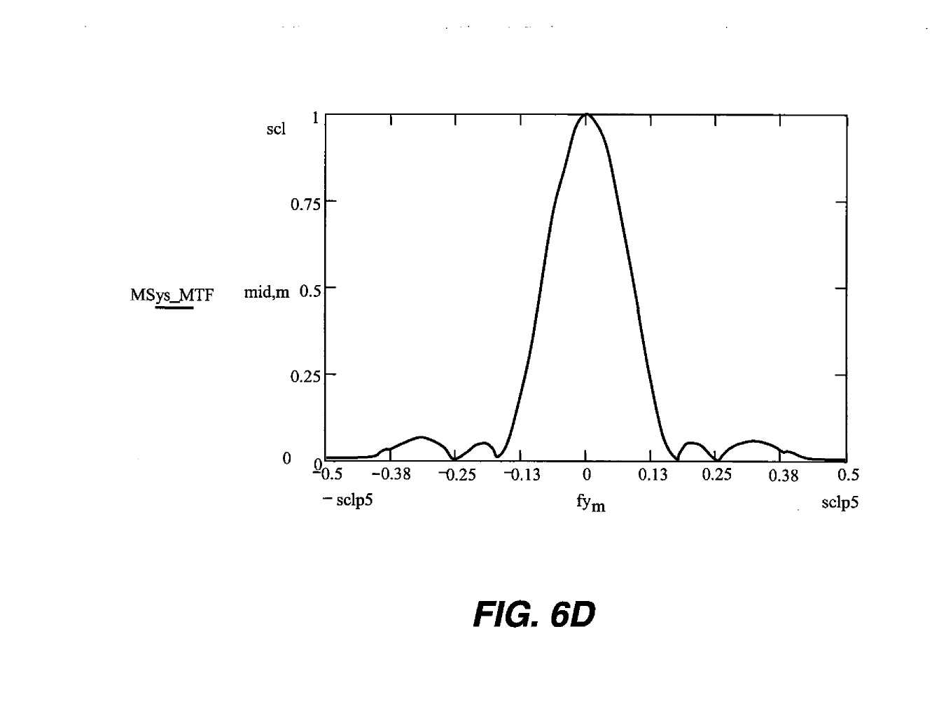

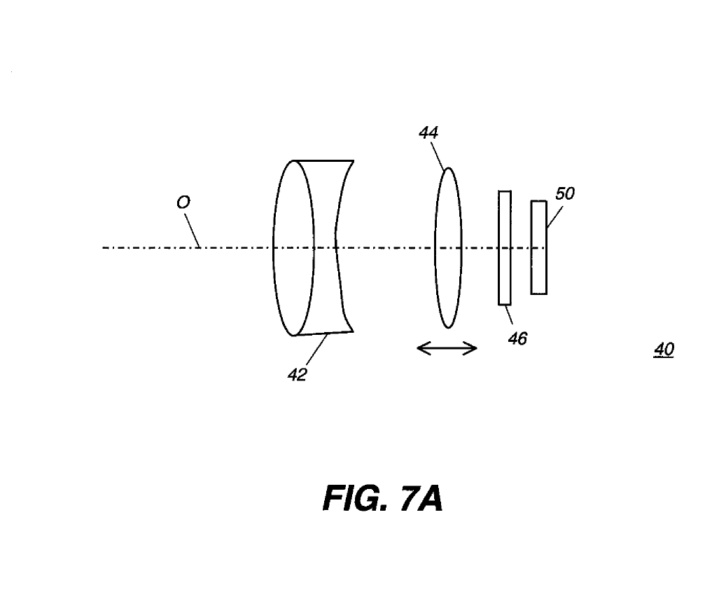

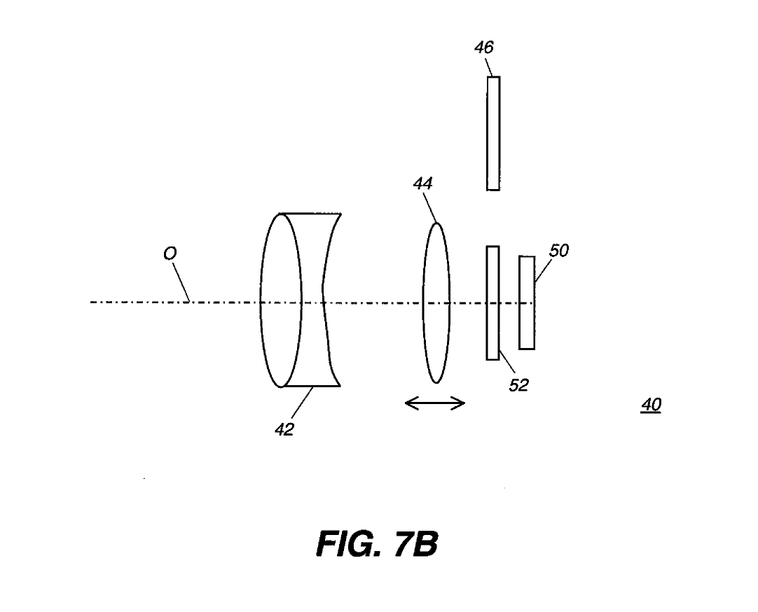

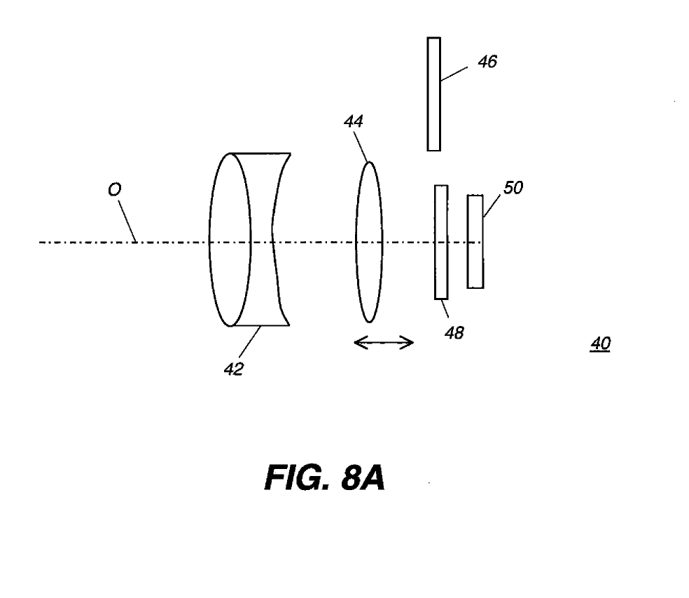

FIG. 6A shows the x-axis MTF of first anti-aliasing filter 10 for providing an 8-spot pattern in one embodiment. FIG. 6B shows the y-axis MTF. The zero is at ½ cycle per sample, the Nyquist frequency.

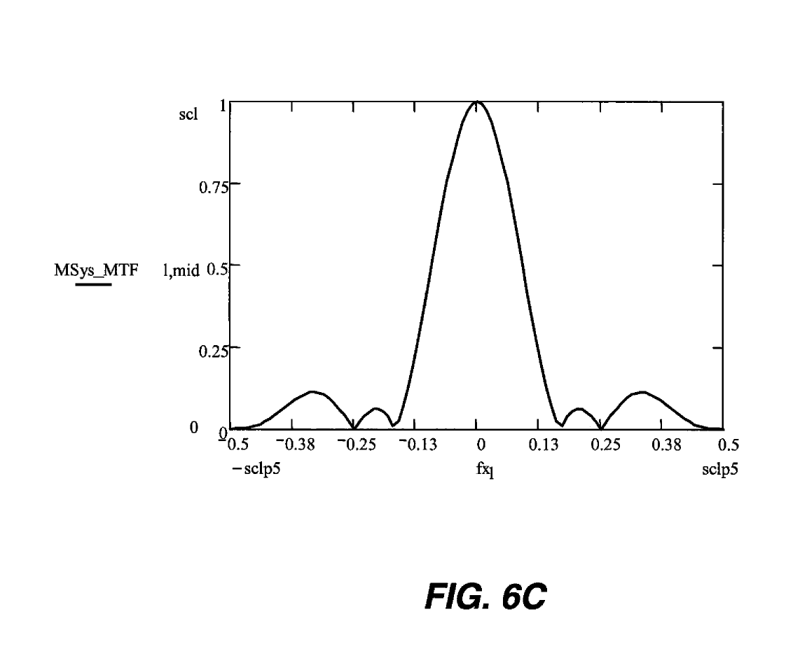

FIG. 4 shows construction and operation details for second anti-aliasing filter 20. Second anti-aliasing filter 20 takes, as input, the 8-spot beam pattern 22 that is provided from first anti-aliasing filter 10 and separates these incident beams to provide an output pattern with a 30 beam spot pattern. This filter uses the arrangement provided for a four-spot, square pattern anti-aliasing filter, again using an arrangement with three birefringent plates. The orientations of z-axes 12d, 12e, and 12f for quartz crystal materials used in successive plates in one embodiment are shown in the upper portion of FIG. 4. Axis 12d has a vertical crystal axis orientation and separates the 8-spot beam pattern with 3 pixel pitch. Axes 12e and 12f are diagonal axes with a pitch that provides further beam separation. As a result of this arrangement, the 8-spot pattern 22 of FIG. 3 is propagated through anti-aliasing filter 20 to provide a 30 spot pattern 24 as is shown in FIG. 5. With this arrangement, spots 26 and 28, at the overlap between 8-spot patterns 22, have twice the intensity of the other spots.

The graphs of FIGS. 6C and 6D show, for x- and y-axes respectively, the combined MTF that is obtained using both first and second anti-aliasing filters 10 and 20, with the arrangement shown in FIGS. 2 through 4. A fill factor of about 0.56 is used for this computation and MTF of lenses in the optical system is ignored. As needed for the pixel sub-sampling scheme used in FIG. 1B, this arrangement provides a very low MTF at and above about ⅙ cycle per imager sample (that is, above 0.1666 cycle per imager sample).

Embodiments of the present invention use one or more anti-aliasing filters, or other type of low-pass filter, to provide anti-aliasing compensation for an imaging apparatus that employs an image sensing array that is operable in a higher-resolution mode and in one or more lower-resolution modes.

Anti-aliasing filters used in various embodiments of the present invention can be seen to increase the effective point spread function (PSF) of the optical system that leads to sensor array 50. The use of two anti-aliasing filters in series tends to further increase the effective point spread function.

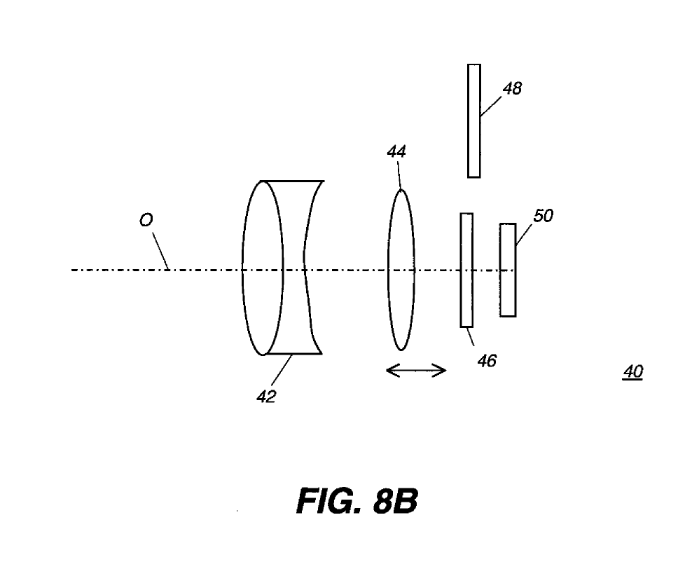

FIGS. 7A and 7B show an imaging apparatus 40 having focus adjustment in schematic form, according to one embodiment. Imaging apparatus 40 can be a digital still and/or video camera, for example. One or more lens elements are used as a photographic objective lens 42. Another lens element 44 may be adjustable along the path of the optical axis O to improve focus, for directing light through a low-pass filter 46 and to a sensor array 50. Low-pass filter 46 may be stationary along optical axis O or other optical path, or may be movable, so that it can be removed from the optical path, as shown in FIG. 7B. When low-pass filter 46 is removed from the optical path, a compensating plate 52 is optionally inserted in the same relative position in order to maintain the optical path length. Compensating plate 52 can be a glass or plastic block, for example. The thickness and material characteristics of compensating plate 52 can be selected to minimize any differences in the optical path length of imaging apparatus 40. Alternatively, an optical element, for example, a lens element having optical power, can be used in place of or in addition to compensating plate 52.

With low pass filter 46 removable in this way, a variable amount of low-pass filtering can be provided for the optical path to sensor array 50. In a lower-resolution mode, low-pass filter 46 can be positioned in the optical path, filtering the light that is directed onto sensor array 50, as shown in FIG. 7A. Then, when a higher-resolution mode is used, low-pass filter 46 is moved to a position that is out of the optical path of imaging apparatus 40. Any of a number of types of well known actuating mechanisms can be used for positioning low-pass filter 46 in an appropriate position for the camera mode. For example, mechanical, electromechanical, or other types of actuator apparatus can be used.

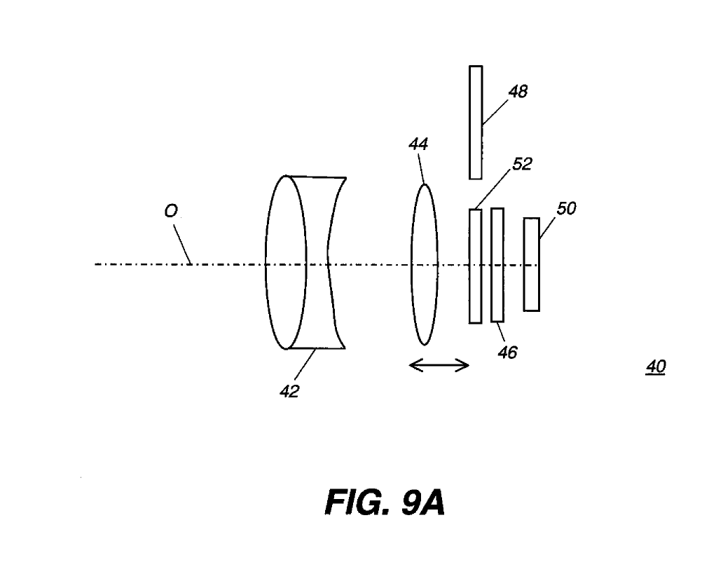

FIGS. 8A and 8B show, in simplified, schematic form, another embodiment of imaging apparatus 40. In this embodiment, there are two different low-pass filters 46 and 48. One of them at a time is switched into position in the optical path, depending on the resolution mode that is being used. Where sensor array 50 is in a higher resolution mode, low-pass filter 48 is switched into the optical path of sensor array 50, as shown in FIG. 8A. Similarly, where sensor array 50 is in a lower resolution mode, low-pass filter 46 is switched into the optical path of sensor array 50. In one embodiment, low pass filter 48 is an 8-spot filter, as described with reference to FIG. 3. Low-pass filter 46 is a four-spot filter, assembled using the arrangement described with reference to FIG. 4. It should be observed that any of a number of other types of low-pass filter arrangements can be used for providing variable low-pass filtering using the switched-filter arrangement of FIGS. 8A and 8B. An additional compensating plate 52 (not shown in FIGS. 8A or 8B) can be used in the optical path if needed with the FIG. 8A and 8B embodiment. This added component is beneficial in situations where differences in thickness or material qualities between filters 46 and 48 might otherwise result in changing the optical path length.

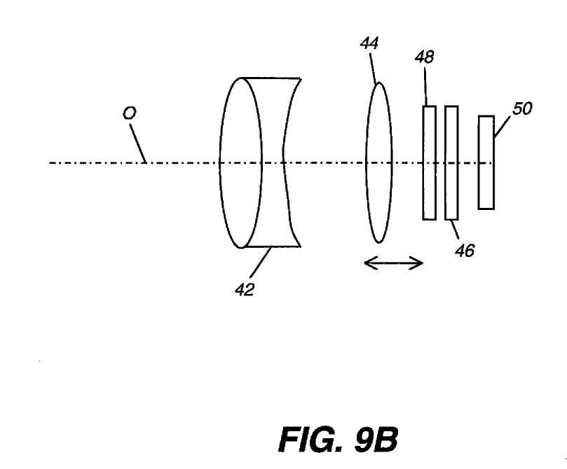

FIGS. 9A and 9B show, again in simplified, schematic form, another embodiment of imaging apparatus 40 using two low-pass filters. The arrangement of FIG. 9A is for low-resolution operation of sensor array 50 in imaging apparatus 40. Low-pass filter 46 is fixed in position along the optical path, here, along optical axis O; filter 48 can be switched into the optical path as needed. Again, compensating plate 52 is optional and can be used to help correct for differences in the optical path length between the one- and two-filter configurations. The FIG. 9A arrangement has filter 48 positioned out of the optical path for low-resolution imaging. Then, when higher resolution is needed, low-pass filter 48 is switched into the optical path of axis O (and compensating plate 52 removed), so that low-pass filters 46 and 48 cooperate to form a suitable spot pattern. In one embodiment, the 30 spot pattern described with reference to FIG. 5 is provided by filters 46 and 48. The eight spot filter is fixed in position along the optical path and is not movable, as is filter 46 in FIGS. 9A and 9B; the 4-spot filter, on the other hand, can be switched into or out of the optical path (axis O in the examples shown) as needed, similar to the movement of filter 48 in FIGS. 9A and 9B. It should be noted that these filters can be used in different order, such as with the 8-spot filter fixed in position and the four-spot filter movable into or out of the optical path. In addition to configurations supporting two resolution modes, a third resolution mode can also be used, in which both low-pass filters 46 and 48 are moved out of the optical path. In embodiments where imaging apparatus 40 has two movable low-pass filters 46 and 48, as many as four resolution modes can be supported. A first resolution mode uses both filters in the optical path; second and third modes use one or the other filter in the optical path; and a fourth mode uses no filters in the optical path.

Filters 46 and 48 can be positioned differently along the optical axis O or other optical path so that either filter is on the image side (that is, closer to sensor 50) with respect to the other.

Low-pass filters used in embodiments of the present invention can be any of a number of types of optical filter, including one or more anti-aliasing filters, such as those described in U.S. Pat. No. 6,937,283 entitled “Anti-Aliasing Low-Pass Blur Filter for Reducing Artifacts in Imaging Apparatus” to Kessler et al.

By providing combinations that employ one or two anti-aliasing filters or other types of low-pass filters in series, embodiments of the present invention enable variable low-pass filtering for the sensor array to support high-resolution-mode operation and one or more low-resolution modes.

The invention has been described in detail with particular reference to certain example embodiments thereof, but it will be understood that variations and modifications can be effected within the scope of the invention. For example, where the present description has been primarily directed to anti-aliasing filters, other types of low-pass filters can equivalently be used, either in combination with one or more anti-aliasing filters or in combination with other low-pass filter types. Embodiments of the present invention allow adaptation for sensor arrays of various types that are capable of operating in variable resolution modes.

### PARTS LIST

10. Anti-aliasing filter
12a, 12b, 12c, 12d, 12e, 12f. Axis
14. Image point
20. Anti-aliasing filter
22, 24. Pattern
26, 28. Spot
30. Image sensing array
40. Imaging apparatus
42. Lens
44. Lens
46. Filter
48. Filter
50. Sensor array
52. Compensating plate

1. A filter system for an imaging apparatus, the imaging apparatus including a high resolution mode of operation and a low resolution mode of operation, the filter system comprising:
a low pass filter associated with an optical path of the imaging apparatus, the low pass filter being moveable into the optical path of the imaging apparatus when the imaging apparatus is in the low resolution mode of operation and moveable out of the optical path of the imaging apparatus when the imaging apparatus is in the high resolution mode of operation.

2. The filter system of claim 1, the low pass filter being a first low pass filter, the filter system further comprising:
a second low pass filter, the second low pass filter being moveable out of the optical path of the imaging apparatus when the imaging apparatus is in the low resolution mode of operation and is moveable into the optical path of the imaging apparatus when the imaging apparatus is in the high resolution mode of operation.

3. The filter system of claim 2 further comprising:
a compensating plate that is movable into or out of the optical path in conjunction with movement of one of the first low pass filter and the second low pass filter.

4. The filter system of claim 1, the low pass filter being a first low pass filter, the filter system further comprising:
a second low pass filter positioned in the optical path of the imaging apparatus when the imaging apparatus is in the low resolution mode of operation and positioned in the optical path of the imaging apparatus when the imaging apparatus is in the high resolution mode of operation.

5. The filter system of claim 4, wherein the first low pass filter is located on an image side of the second low pass filter when the first low pass filter is positioned in the optical path of the imaging apparatus.

6. The filter system of claim 4, wherein the first low pass filter is configured to increase an effective point spread function of the filter system when compared to an effective point spread function produced by the second low pass filter alone.

7. The filter system of claim 1, further comprising:
an optical element, the optical element being moveable in to the optical path of the imaging apparatus when the low pass filter is out of the optical path of the imaging apparatus and moveable out of the optical path of the imaging apparatus when the low pass filter is in the optical path of the imaging apparatus.

8. The filter system of claim 1, further comprising:
a compensating plate that is movable into or out of the optical path in conjunction with movement of the low pass filter.

9. The filter system of claim 1, further comprising:
a color filter array located in the optical path of the imaging apparatus.

10. The filter system of claim 9, wherein the color filter array includes panchromatic pixels.

11. A multi-resolution filter system comprising:
a plurality of low pass filters, at least some of the plurality of low pass filters being positionable on and off of an optical axis;
a mechanism operatively associated with the at least some of the plurality of low pass filters positionable on and off the optical axis, the mechanism being operable to produce combinations of low pass filters positioned on the optical axis by moving one or more of the associated plurality of low pass filters laterally relative to the optical axis, wherein each combination of low pass filters produces distinct anti-aliasing characteristics when compared to other combinations of low pass filters.

12. The filter system of claim 11 further comprising:
a compensating plate that is movable into or out of the optical path in conjunction with movement of at least some of the low-pass filters.

13. A method of filtering in an imaging apparatus including a high resolution mode of operation and a low resolution mode of operation, the method comprising:
providing a low pass filter associated with an optical path of the imaging apparatus;
moving the low pass filter into the optical path of the imaging apparatus when the imaging apparatus is in the low resolution mode of operation; and
moving the low pass filter out of the optical path of the imaging apparatus when the imaging apparatus is in the high resolution mode of operation.

14. The method of claim 13, further comprising:
providing a compensating plate; and
moving the compensating plate into the optical path in conjunction with moving the low pass filter out of the optical path.

15. The method of claim 13, the low pass filter being a first low pass filter, the method further comprising:
providing a second low pass filter;
moving the second low pass filter out of the optical path of the imaging apparatus when the imaging apparatus is in the low resolution mode of operation; and
moving the second low pass filter into the optical path of the imaging apparatus when the imaging apparatus is in the high resolution mode of operation.

16. The method of claim 14, further comprising:
providing a compensating plate; and
moving the compensating plate into the optical path in conjunction with movement of one of the first low pass filter and the second low pass filter out of the optical path.

17. The method of claim 13, the low pass filter being a first low pass filter, the method further comprising:
providing a second low pass filter positioned in the optical path of the imaging apparatus when the imaging apparatus is in the low resolution mode and when the imaging apparatus is in the high resolution mode of operation.

18. The method of claim 13, further comprising:
providing an optical element; and
moving the optical element into the optical path of the imaging apparatus when the low pass filter is out of the optical path of the imaging apparatus; and
moving the optical element out of the optical path of the imaging apparatus when the low pass filter is in the optical path of the imaging apparatus.

19. The method of claim 13, further comprising:
providing a color filter array positioned in the optical path of the imaging apparatus.
